(19) United States
(12) Patent Application Publication
(10) Pub. No.: US 2007/0007773 A1
(43) Pub. Date: Jan. 11, 2007

(54) Quick cam latch mechanism

(76) Inventors: John K. Berkseth, Rice Lake, WI (US); Michael W. Kondratuk, Cameron, WI (US)

Correspondence Address: Moss & Barnett P.A.;4800 Wells Fargo Center, 90 South Seventh Street, Minneapolis, MN, 55402-4129, US

(21) Appl. No.: 11/177,069

(22) Filed: Jul. 8, 2005

(51) Int. Cl. E05C 1/12

(52) U.S. Cl. 292/169

(57) ABSTRACT

A quick cam latch mechanism having an operatively coupled bolt and cam assembly disposed in a latch housing. A handle is coupled to the cam assembly for moving the bolt between an extended or engaged position and a retracted or disengaged position. The cam assembly includes a primary cam operatively coupled to a secondary cam or linkage that is in turn operatively coupled to the bolt. Rotation of the primary cam translates into increased pivoting of the linkage and thereby increased retraction of the bolt. As a result, less rotation of primary cam is needed to retract the bolt. In an example embodiment of the invention, at least two linkages are utilized to quickly retract the bolt regardless of the direction of rotation of the handle.

### BACKGROUND OF THE INVENTION

1. Field of the Invention

The present invention is directed to a latch for mounting to a door and in particular to a rotary type latch that requires less handle rotation during operation.

2. Description of the Related Art

Latches mounted to or within a door are well known and typically include a latch housing and bolt. In one common type of latch, the bolt is typically operatively coupled or connected to a handle. Rotation of the handle in either a clockwise or counterclockwise direction draws or retracts the bolt into the housing. The bolt is retractable into the housing to permit the door to swing freely. In its extended position, the bolt is adapted to strike and engage a strike plate thereby preventing free movement of the door.

The handle acts on a cam operatively disposed within the housing which in turn acts upon and retracts the bolt. The handle of the conventional latches had to be rotated approximately 60 degrees in either direction in order to fully retract the bolt and permit free movement of the door. More recent devices, however, have been developed that utilize a secondary cam to increase the rate at which the bolt retracts into the housing. One such devise is illustrated in U.S. Pat. No. 5,690,372 to Jans. Devises of this type have an advantage of retracting the bolt more quickly into the housing with less rotation of the handle. However, they have the disadvantage of being complicated and difficult to manufacture.

What is needed in the lock and latch industry is a rotatable latch that utilizes a novel cam assembly to quickly retract a bolt into a latch housing by rotating a latch handle generally less than 60 degrees. What is also needed in the lock and latch industry is a rotatable latch utilizing an uncomplicated, yet novel cam assembly to draw the bolt into the housing.

### SUMMARY OF THE INVENTION

Example embodiments of the invention relate to a latch mechanism that retracts a bolt by rotation of a handle less than 60 degrees. The invention includes a bolt slideably mounted in a latch housing that can be mounted either on or in a door. The handle for retracting the bolt extends into and/or through the housing to engage a primary cam and at least one secondary cam or linkage. The linkage is disposed generally between and operatively coupled to the bolt and the primary cam. Rotation of the handle in turn rotates the primary cam which engages and directly rotates the linkage. The linkage in turn engages and retracts the bolt at an accelerated rate.

In another example embodiment of the invention, a handle-spindle assembly is utilized to rotate or pivot primary cam such that rotation of the handle in turn rotates the spindle and concurrently the primary cam. As discussed above, the primary cam acts upon the linkage to retract or draw the bolt into the housing at an accelerated rate compared to the rate of rotation of the handle and the primary cam. Depending upon the type of handle utilized, when a user releases the handle it can be automatically extended, pivoted, rotated, or repositioned to a pre-actuated position with at least a portion of the bolt extending away from or out of the door.

In yet another example embodiment of the invention, the primary cam acts upon first and second linkages that quickly retract or draw the bolt into the housing depending upon the rotation or pivoting of the handle. Movement of the handle in a clockwise or first direction causes the primary cam to act upon the first linkage. Movement of the handle in a counter clockwise or second direction causes the primary cam to act upon the second linkage. In either direction the bolt is easily and quickly drawn into the housing.

It is an object of the present invention to provide a latch mechanism that is easy to use and inexpensive to manufacturer.

It is another object of the present invention to provide a bolt of a latch mechanism that has an increased rate of retraction compared to a rate of rotation of a handle.

It is yet another object of the present invention that rotation of the handle less than 60 degrees in either a clockwise or counterclockwise direction fully retracts the bolt into the housing.

The above summary of the invention is not intended to describe each illustrated embodiment or every implementation of the invention. Instead, the summary of the invention is provided to aid the reader in understanding the novel concepts illustrated or depicted in the following brief description of the drawings.

### BRIEF DESCRIPTION OF THE DRAWINGS

The invention may be more completely understood in consideration of the following detailed description of various embodiments of the invention in connection with accompanying figures, in which:

FIG. 1 is a first perspective view of a quick cam latch mechanism according to an example embodiment of the present invention.

FIG. 2 is a second perspective view of the quick cam latch mechanism of FIG. 1 according to an example embodiment of the present invention.

FIG. 3 is an exploded view of an example embodiment of the quick cam latch mechanism according to an example embodiment of the present invention.

FIG. 4 is a perspective view of a housing according to an example embodiment of the present invention.

FIG. 5 is a perspective view of a cover according to an example embodiment of the present invention.

FIG. 6 is a perspective view of a latch bolt illustrating a first side surface thereof, according to an example embodiment of the present invention.

FIG. 7 is a perspective view of the latch bolt of FIG. 6 illustrating a second opposite side surface thereof.

FIG. 8a is a perspective view of a primary cam according to an example embodiment of the present invention.

FIG. 8b is a perspective view of the primary cam of FIG. 8a illustrating a opposite side surface thereof.

FIG. 9a is a perspective view of a secondary cam or linkage according to an example embodiment of the present invention.

FIG. 9b is a perspective view of FIG. 9a from an opposite side.

FIG. 9c is a side view of the linkage of FIG. 9b.

FIG. 10a is a perspective view of a secondary cam or linkage according to an example embodiment of the present invention.

FIG. 10b is a perspective view of the secondary cam or linkage of FIG. 10a from an opposite side.

FIG. 11 is a side plan view of the primary cam and first and second linkages disposed in the cover according to an example embodiment of the present invention.

FIG. 12 is a side plan view illustrating a bolt in an extended position and in operative communication with the housing, primary cam and the first and second linkages according to an example embodiment of the present invention.

FIG. 13 is a side plan view of a bolt disposed proximate the cover and in operative communication to the primary cam and the first and second linkages. The bolt is illustrated in a retracted position according to an example embodiment of the present invention.

FIG. 14 is a side plan view of a bolt in a retracted position and in operative communication with the housing, primary cam and the first and second linkages according to an example embodiment of the present invention.

While the invention is amendable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF PREFERRED EMBODIMENTS

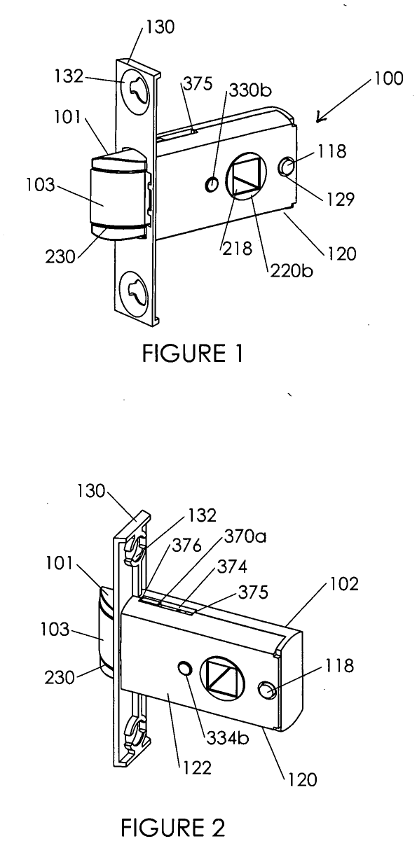

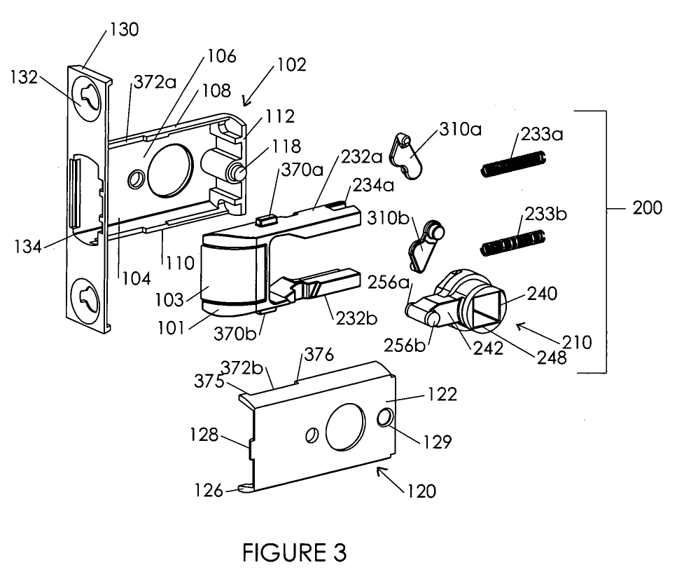

FIGS. 1 through 14 collectively illustrate a quick cam latch mechanism, indicated by the numeral 100, to control the free movement of a door and/or window. An example embodiment of the invention, as illustrated in FIGS. 1-4, includes a bolt 101 operatively disposed to or within a latch housing 102 having an interior 104 defined by a side wall 106 (see FIG. 3), a top wall 108, a bottom wall 110, and rear wall 112 such that housing 102 includes a generally open side.

Referring to FIGS. 1-3 and 5, the interior 104 of housing 102 can be selectively covered by a cover 120 having a side wall 122 and top and bottom walls 124 and 126. As particularly illustrated in FIGS. 1 and 2, top wall 108 and bottom wall 110 of housing 102 are confrontable and/or mateable with top wall 122 and bottom wall 124 of cover 120 to selectively enclose at least a portion of the interior 104 of housing 102.

Referring to FIGS. 1-4, a face plate 130 is at least detachably coupled, mounted to or formed with housing 102 for securing housing 102 to or within a latch cavity of a door. Face plate 130 includes at least one fastener opening 132 for receiving a fastener used to fasten housing 102 to a portion of the door. In the example embodiments illustrated in FIGS. 1-4, face plate 130 includes a pair of spaced apart fastener openings. One skilled in the art will appreciate that face plate 130 can be adapted to receive a number of different fasteners such as, screws, security fasteners, and the like.

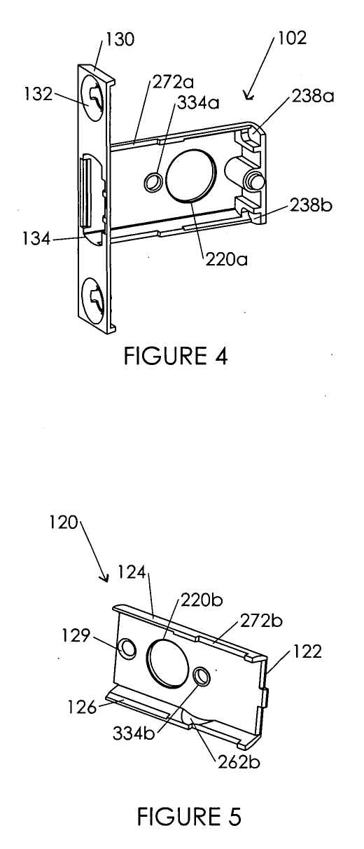

Referring to FIGS. 3-4, a bolt opening 134 is formed in or extends through face plate 130 for receiving bolt 101 as it travels between the extended and retracted positions. Bolt opening 134 is defined by a peripheral edge formed in face plate 130 having a shape adapted to permit free movement of bolt 101 in housing 102.

Referring to FIGS. 1-5, housing 102 and cover 120 can be coupled, secured and/or attached together by numerous methods, including, but not limited to, rivets, fasteners and/or inter-component engagement. Inter-component engagement, as illustrated in the example embodiments of FIGS. 1-5, can include cover 120 having a tongue, lip or the like 128 that is mateable with a portion of face plate 130. Face plate 130 can include a tongue opening or slit 136 formed therein for receiving and securing a front portion of cover 120 to housing 102. Cover 120 can also include a boss opening 129 extending therethrough for receiving at least one boss 118 formed on or adjacent to an inner surface of the rear wall 112 of housing 102. Boss 118 can be pressure fitted within boss opening 129 of cover 120 to secure the rear portion of cover 120 to housing 102. Other forms of inter-component engagement are also envisioned within the spirit and scope of the invention. Other types of engagement such as hinges and clasps, track and groove and the like are also considered to be within the scope and spirit of the invention.

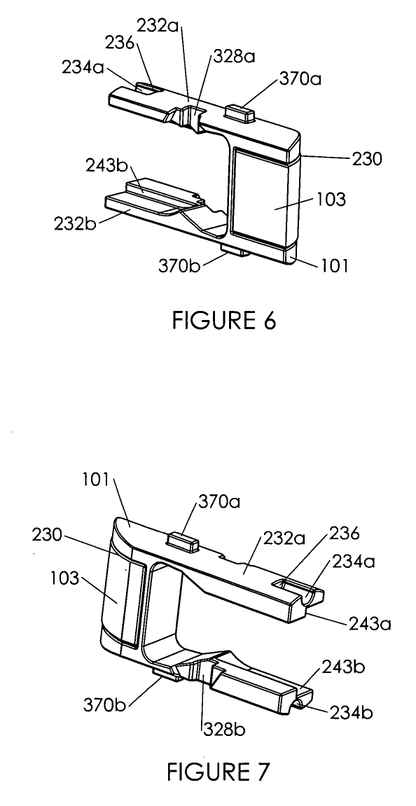

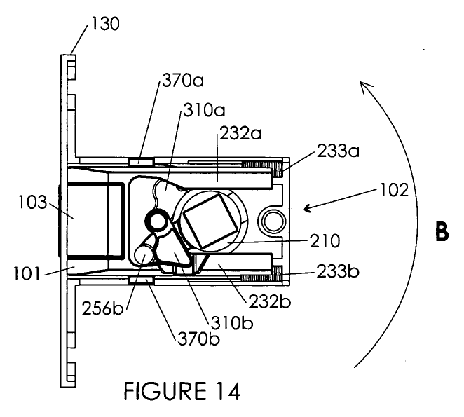

Referring to FIGS. 3, and 11-14, enclosed or encased within the joined housing 102 and cover 120 is bolt 101 and a cam assembly 200 that is used to move bolt 101 between the retracted and extended positions. As illustrated in FIGS. 6 and 7, bolt 101 includes a tapering free end or engagement portion 230 and a pair of spaced leg portions 232a and 232b extending away from a rear or back of bolt 101. As illustrated in FIGS. 1 and 2, engagement portion 230 extends out of bolt opening 134 when bolt 101 is in the extended position. As particularly illustrated in FIG. 14, a free end of engagement portion 230 is positioned generally adjacent to face plate 130 when bolt 101 is in the retracted position.

Returning to FIGS. 6 and 7, a width of engagement portion 230 can taper generally from leg portions 232a and 232b toward the free end thereof. The tapering width of bolt 101 assists in the movement of bolt 101 from the extended position toward the retracted position upon engagement with a strike latch mounted on a door jamb. Engagement portion 230 can also have a generally uniform width such that bolt 101 is similar to a deadbolt. Other configurations of bolt 101 and its portions are also considered to be within the spirit and scope of the invention. Additionally, an engagement cover or wear surface 103 can be formed in or attached to bolt 101 to provide a bolt surface that reduces the amount of wear and/or resistance created by bolt 101 repeatedly engaging a strike latch mounted on a door jamb.

Referring now to FIGS. 3 and 11-14, cam assembly 200 is generally disposed between and operatively confronting leg portions 232a and 232b of bolt 101. In one example embodiment of the invention, cam assembly 200 can include a primary cam 210 that confronts or engages first cam 310a and/or secondary cam 310b that in turn confront or engage either one or both of leg portions 232a and 232b drawing bolt 101 from the extended position toward the retracted position.

Cam assembly 200 also includes at least one biasing member, means or spring that is operatively disposed between rear wall 112 of housing 102 and bolt 101 to bias bolt 101 in the extended position. In the example embodiments of FIGS. 3 and 11-14, a pair of biasing members 233a and 233b are disposed between and axially aligned with leg portions 232a and 232b respectively. As illustrated in FIGS. 3 and 7, leg portions 232a and 232b can include a channel or groove 234a and 234b formed therein for receiving biasing members 233a and 233b. Each of channels 234a and 234b includes an abutment surface 236 for abutting an end of each of the biasing members 233a and 233b disposed within the channels 234a and 234b. Opposed ends of the biasing members 234a and 234b can be disposed in catches 238a and 238b consisting of a generally curved or arcuate walls extending away from rear wall 112 of housing 102. When bolt 101 is disposed in housing 102, channels 234a and 234b and catches 238a and 238b are generally in registration with each other such that perpendicular or lateral movement of biasing members 233a and 233b is restricted.

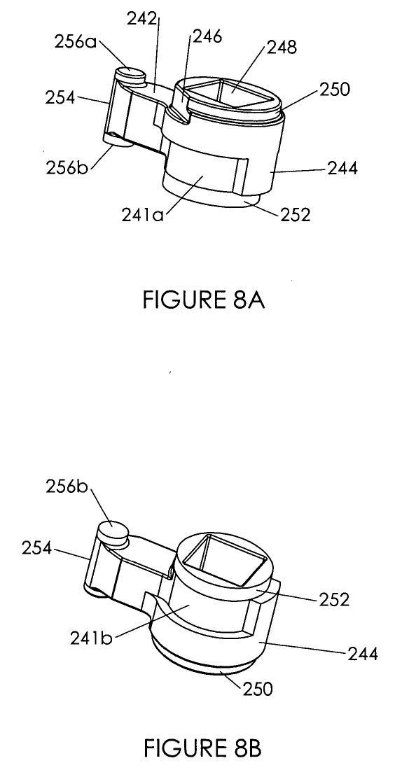

Referring to FIGS. 3 and 8, primary cam 210 includes a body portion 240 and an arm portion 242 extending away therefrom that confronts or engages linkages 310a and/or 310b. The body portion 240 can have a generally cylindrical shape to reduce the amount of space needed in interior 104 of housing 102. The cylindrical shape of body portion 240 of primary cam 210 is to facilitate rotation or pivoting of primary cam either by a handle or handle spindle assembly. In another embodiment of the invention, primary cam 210 can also have the shape of an arm, rod or lever with one end pivotally coupled to at least the housing and/or cover. Primary cam 210 in this example embodiment pivots in either a clockwise or counterclockwise direction to engage linkages 310a and/or 310b which engage and quickly retract bolt 101.

When body portion 240 is generally cylindrical in shape, as particularly illustrated in FIGS. 8a and 8b, an outer surface 244 of body portion 240 can have a linkage receiving portion, channel or groove 246 formed therein for receiving a portion of linkages 310a and/or 310b when bolt 101 is in the retracted position. Body portion 240 can have multiple linkage receiving portions or grooves disposed about its outer surface 244 to receive either the first 310a or second 310b linkages depending upon the direction of rotation of primary cam 210. Additionally, the multiple linkage receiving portions or channels can be on opposite sides of arm 242 to accommodate linkages 310a and 310b being disposed on opposite sides of primary cam 210.

Referring to FIGS. 6-8B, body portion 240 can also include a clearance section, groove or depression 241 extending generally about a portion thereof. The clearance sections 241a and/or 241b permits free rotation of primary cam 210 between leg portions 232a and 232b of bolt 101. In particular, leg portions 232a and 232b each can include a step or elevated portion 243a and 243b for adding strength thereto. Upon rotation of primary cam 210 clearance sections 241a and/or 241b rotate adjacent, over or near step portions 243a and 243b respectively.

Primary cam 210, although not illustrated, is operatively couplable to a handle or handle-spindle assembly that is used to pivot or rotate primary cam 210 and concomitantly linkages 310a and/or 310b. In one example embodiment, at least one handle or spindle bore 248 extends into and/or through body portion 240 of primary cam 210 for receiving the handle or handle-spindle assembly. Spindle bore 248 can have any cross sectional shape corresponding to a cross section of the handle or handle-spindle assembly. When primary cam 210 is disposed between housing 102 and cover 120, as illustrated in FIGS. 1 and 2, spindle bore 248 is in registration with cam openings 220a and 220b extending through housing 102 and cover 120 respectively. Cam openings 220a and 220b, along with spindle bore 248 are all in registration with an opening extending through the door to permit operative coupling of the handle or handle-spindle assembly with primary cam 210

As particularly illustrated in FIGS. 1-2 and 8a-8b, primary cam 210 can be rotatably or pivotally suspended or disposed between housing 102 and cover 120 to permit operative engagement with linkages 310a and/or 310b. As particularly illustrated in FIGS. 8a-8b, primary cam 210 can have a housing bearing surface 250 and a cover bearing surface 252 formed on body portion 240 for confronting edge surfaces defining cam openings 220a and 220b. In one example embodiment, bearings can be disposed on bearing surfaces 250 and 252 to facilitate rotation or pivoting of primary cam 210.

Turning now to arm portion 242, and particularly to FIGS. 1 and 8a-8b, it is notable that a width of arm portion 242 can taper toward a free end 254 thereof for reducing the amount of space needed in the interior 104 of housing 102. Additionally, free end 254 can include a pair of axially disposed protuberances 256a and 256b extending oppositely away from each other and generally perpendicularly away from a long axis thereof for operatively confronting at least one of linkages 310a or 310b. The axial disposition of protuberances 256a and 256b with respect to each other and arm portion 242 ensures proper engagement with either of linkages 310a and 310b depending upon rotation of the handle and primary cam in either the clockwise or counterclockwise direction. In a preferred example embodiment, engagement between arm portion 242 of primary cam 210 with either of linkages 310a and 310b is enough to draw bolt 101 from the extended position toward the retracted position.

Referring now to FIGS. 3 and 9a-10b, linkages 310a and 310b are pivotally coupled to or in housing 102 and cover 120 respectively with primary cam 210 disposed therebetween. Linkages 310a and 310b comprise a blade or body portion 320a and 320b having a generally curved or arcuate peripheral edge or profile 322a and 322b that generally faces toward face plate 130. A peg portion 324a and 324b or like structure extends generally perpendicularly away from a first surface 326a of blade portion 320a and a first surface 326b of blade portion 320b to engage a linkage notch 328a and 328b (see FIGS. 6 and 7) formed in each of spaced leg portions 232a and 232b respectively. As particularly illustrated in FIGS. 6 and 7, linkage notch 328a is formed in a rear surface of bolt 101 that faces or is adjacent to housing 102 while linkage notch 328b extends into a front surface of bolt 101 that faces or is adjacent to cover 120. As illustrated in FIG. 3, peg portions 324a and 324b of linkages 310a and 310b, respectively, extend toward or in the direction of primary cam 210 and engage linkage notches 328a and 328b.

Linkages 310a and 310b are pivotally coupled to housing 102 and cover 120 by a post 330a and 330b that extends from a generally opposite second surface 332a and 332b of body portions 320a and 320b respectively. Post 330a of linkage 310a is pivotally disposable in a linkage opening 334a extending into housing 102 (see FIG. 3) while post 330b of linkage 310b is pivotally disposable in a linkage opening 334b extending into cover 120 (see FIG. 3). Linkages 310a and 310b can also be coupled to housing 102 and cover 210 respectively by other means such as screws, bolts, and the like.

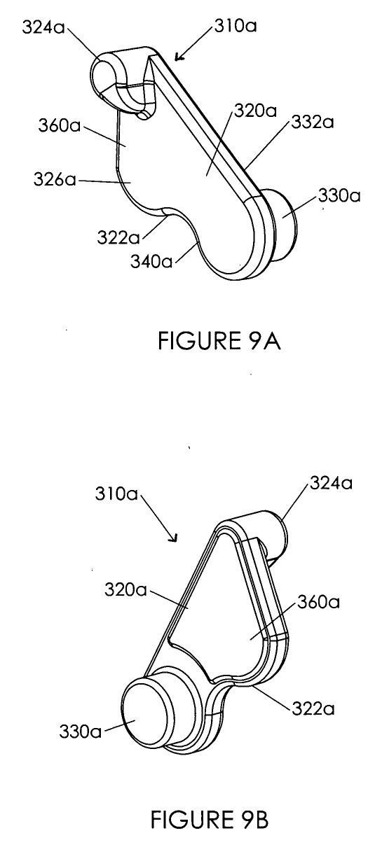

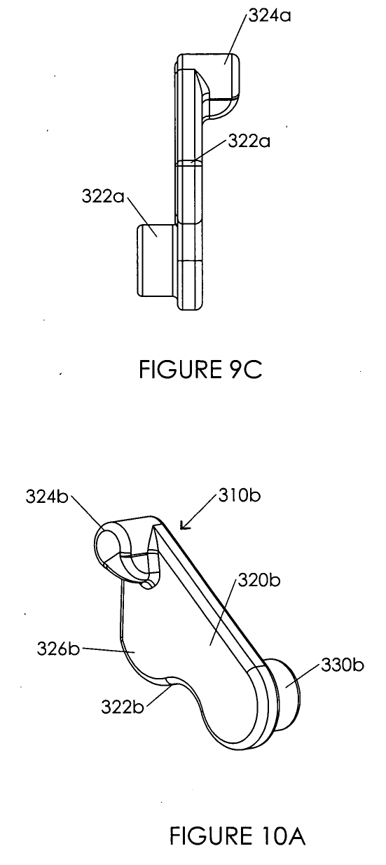

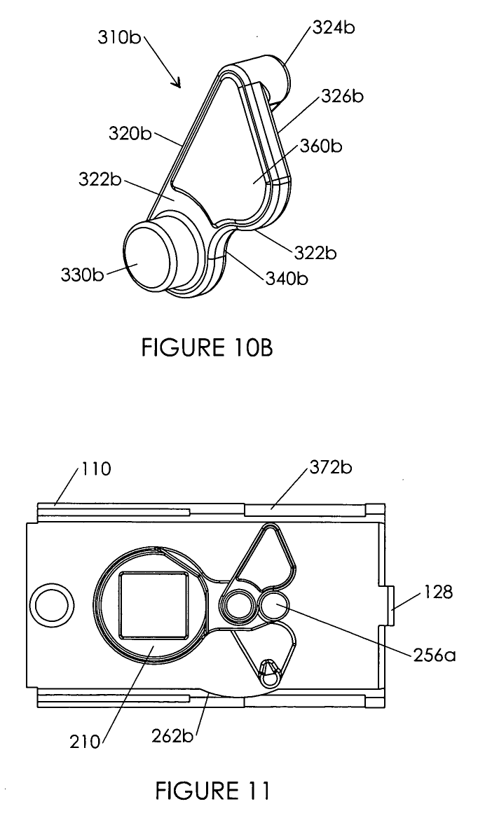

Referring to FIGS. 9a-9c and 10a-10b, linkages 310a and 310b have flared or expanded portions 360a and 360b proximate pegs 324a and 324b. The flared portions 360a and 360b create the undulating peripheral edges 322a and 322b respectively. Flared portions 360a and 360b facilitate the increased rate at which linkages 310a and 310b pivot thereby directly increasing the rate of retraction of bolt 101 into housing 102. In general, the greater the flaring of flared portions 360a and 360b, the greater the rate of pivoting of linkages 310a and 310b and the greater the rate of retraction for bolt 101.

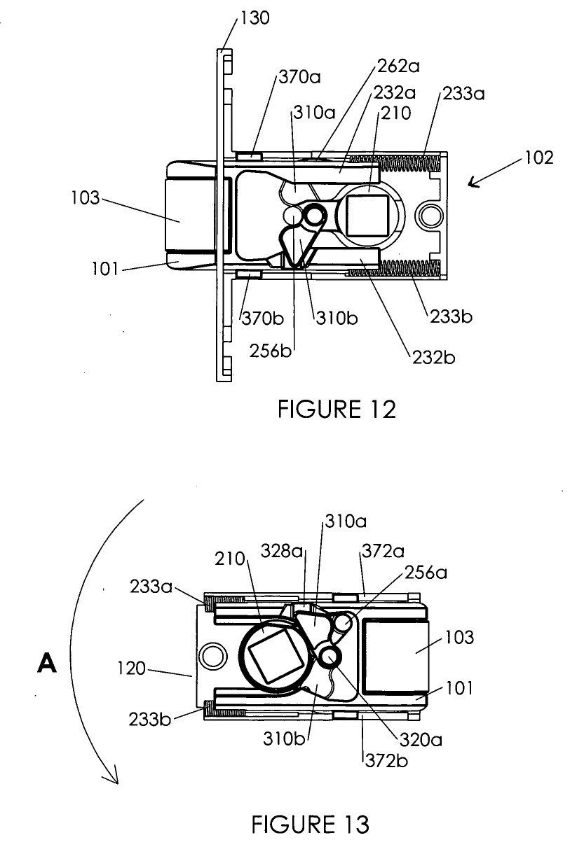

The following discussion of the use of example embodiments will assist the reader in understanding all of the novel features of the invention. Referring to the example use illustrated in FIGS. 11-14, primary cam 210 and linkages 310a and 310b each travel along arcuate paths as linkages 310a and 310b retract bolt 101 from the extended position toward the retracted position. When bolt 101 is in the extended position, as illustrated in FIGS. 11 and 12, protuberances 256a and 256b are axially aligned with a long axis of housing 102 and cover 120. Additionally, in the extended position, protuberances 256a and 256b are disposed in a seat section 340a and 340b formed in the undulating peripheral edges 322a and 322b (see FIGS. 9a-9c and 10a-10b) of linkages 310a and 310b. While in seat sections 340a and 340b protuberances 256a and 256b are proximate posts 330a and 330b.

As the handle or handle-spindle assembly is rotated, primary cam 210 and arm portion 242 are pivoted or rotated. Rotation of primary cam 210 in a first direction, indicated by the arrow A in FIG. 13, causes arm portion 242 and protuberance 256a to travel upward along an arcuate path. While traveling along the arcuate path protuberance 256a continuously engages peripheral edge 322a of linkage 310a. Rotation of primary cam 210 in a second direction, indicated by the arrow B in FIG. 14, causes arm portion 242 and protuberance 256b of primary cam 210 to travel in a downward arcuate path. While traveling along the downward arcuate path protuberance 256b continuously engages peripheral edge 322b of linkage 310b.

As either protuberance 256a or 256b travels along in the first or second direction, continuously engaging the undulating peripheral edge 322a or 322b they begin to engage the flared portion 360a or 360b of linkage 310a or 310b. As protuberance 256a or 256b engages flared portion 360a or 360b less rotation or pivoting of primary cam 210 translates into greater rotation or pivoting of linkage 310a or 310b. The differential between the amount of rotation or pivoting of primary cam 210 and linkage 310a or 310b permits linkage 310a or 310b to quickly retract bolt 101. The increased rate of retraction of bolt 101 also eliminates the need to have handle or handle-spindle assembly rotate a full 60 degrees in either the first or second direction. In one example embodiment, rotation of the handle or handle-spindle assembly approximately 22 degrees can fully retract bolt 101. However, one skilled in the art will understand after reading the above description that increasing or decreasing the amount of flaring of linkage 310a or 310b will vary the amount of rotation needed to fully retract bolt 101.

As illustrated in FIGS. 13 and 14, when bolt 101 is disposed in the retracted position both linkages 310a and 310b confront primary cam 210. Both linkages 310a and 310b are retracted regardless of the rotational direction of the handle or handle-spindle assembly due to the continuous engagement of pegs 324a and 324b of linkages 310a and 310b in linkage notches 328a and 328b of bolt 101. As illustrated in FIGS. 13 and 14, upon fully retracting bolt 101, pegs 324a or 324b begin to reach a descending section of the flared portion 360a or 360b of linkages 310a or 310b. Upon reaching the descending section the amount of displacement of linkages 310a or 310b by pegs 324a or 324b is reduced. As a result, less force and wear is exerted upon linkages 310a or 310b.

As illustrated in FIGS. 11 and 12, housing 102 and cover 120 can have depressions or recesses 262a and 262b extending into the top wall 108 and/or bottom wall 126 of housing 102 and cover 120 respectively for permitting passage of a tip or end of linkages 310a and 310b as bolt 101 moves between the extended and retracted positions. Lastly, bolt 101 can have at least one stop to limit the sliding movement of bolt 101 in housing 102 and cover 120. As illustrated in FIGS. 2 and 3, bolt 101 can have two stops 370a and 370b, each of which can extend from one of the leg portions 232a and 232b respectively or from opposed sides of the engagement portion 230. Stops 370a and 370b can travel in channels 372a and 372b formed in housing 102 and cover 120 respectively that when combined forms a slot 374. The ends 375 and 376 of slot 374 form abutment surfaces that limit or stop movement or sliding of bolt 101.

Once the door is utilized a user can release the handle allowing biasing members 233a and 233b to expand forcing bolt 101 from the retracted position toward the extended position. As bolt 101 moves toward the extended position linkages 310a and 310b are concurrently pivoted or rotated away from primary cam 210. As linkages 310a and 310b pivot away from primary cam 210 their peripheral edges 322a or 322b (depending upon initial direction of rotation of handle) engage protuberances 256a or 256b, and concurrently arm portion 242, until arm portion 242 comes to rest in seat sections 340a and 340b of linkages 310a and 310b. In the resting state the arm portion 242 of primary cam 210 is axially aligned with the longitudinal axis of housing 102 and cover 120 until a subsequent operation or actuation.

What is claimed is:

1. A quick cam latch mechanism comprising:
a housing;
a bolt disposed in the housing, the bolt being positionable between an extended position and a retracted position; and
a cam assembly disposed in the housing and operatively coupled to the bolt, the cam assembly having at least one rotatable primary cam that is in operative contact with at least one pivotal linkage adapted to pivot at a rate generally greater than a rate of rotation of the primary cam, the linkage being operatively coupled to the bolt, wherein rotation of the primary cam directly pivots the at least one linkage which in turn translates into linear retraction of the bolt from the extended position toward the retracted position.

2. The latch assembly of claim 1, further comprising a handle operatively coupled to the primary cam to actuate the cam assembly and retract the bolt into the housing.

3. The latch assembly of claim 1, wherein the cam assembly further comprises at least one biasing member disposed in the housing and operatively confronting at least a portion of the bolt, wherein the biasing member moves the bolt from the retracted position toward the extended position.

4. The latch assembly of claim 3, wherein the biasing member comprises a coiled spring.

5. The latch assembly of claim 1, wherein the bolt comprises a body portion and a pair of spaced leg portions extending away therefrom, the at least one linkage operatively confronting at least one of the leg portions.

6. The latch assembly of claim 5, wherein the leg portion includes a linkage notch formed therein, the at least one linkage being selectively engaged with the linkage notch.

7. The latch assembly of claim 5, wherein the leg portion includes a linkage notch formed therein, the at least one linkage being continuously engaged with the linkage notch.

8. The latch assembly of claim 1, wherein the at least one linkage has an undulating peripheral edge defining a flared portion, wherein engagement between the primary cam and the flared portion of the linkage increases the rate of pivoting of the linkage and thus increases the rate retraction of the bolt.

9. The latch assembly of claim 8, wherein the primary cam has an arm portion having a pair of opposed protuberances that engage the peripheral edge of the at least one linkage.

10. The latch assembly of claim 8, wherein the at least one linkage has a post portion extending away therefrom pivotally coupling it to a portion of the housing.

11. The latch assembly of claim 8, wherein the at least one linkage has a peg portion extending away therefrom and extending into and operatively confronting a linkage notch formed in a portion of the bolt.

12. The latch assembly of claim 1, wherein the cam assembly comprises a pair of linkages, the pair of linkages being operatively disposed on opposed sides of the primary cam such that rotation of the primary cam in opposed directions causes engagement of the primary cam with either of the linkages.

13. A latch assembly comprising:
a housing and a cover defining an interior of the housing;
a bolt slidably disposed in the interior of the housing, the bolt being positionable between an extended position and a retracted position;
a first linkage pivotally coupled to a portion of the housing to engage at least a portion of the bolt, the first linkage having a flared portion defining an undulating peripheral edge;
a second linkage pivotally coupled to a portion of the cover to engage at least a portion of the bolt, the second linkage having a flared portion defining an undulating peripheral edge;
a primary cam rotationally disposed at least partially between the first and second linkages, rotation of the primary cam in a first direction causes it to engage at least a portion of the first linkage, rotation of the primary cam in a second direction causes it to engage at least a portion of the second linkage;
a handle rotatably coupled to the primary cam to rotate the primary cam in the first and second directions; and
wherein upon rotation of the primary cam in either of the first and second directions, a portion of the primary cam engages the flared portion of at least one of the first and second linkages creating a rotational differentiation between a rate of rotation of the primary cam and a rate of pivoting of the linkages such that the rate of pivoting of the first and second linkages is generally greater than a rate of rotation of the primary cam, whereby the increased rate of pivoting of the linkages translates into an increased linear retraction of the bolt.

14. The latch assembly of claim 13, further comprising a biasing member disposed between the bolt and a portion of the housing to bias the bolt from the retracted position toward the extended position.

15. The latch assembly of claim 13, wherein the bolt has a body portion and a pair of spaced leg portions extending away therefrom, the first and second linkages operatively coupling the leg portions.

16. The latch assembly of claim 15, wherein each of the spaced leg portions includes linkage notch extending therein for receiving a portion of the first and second linkages.

17. The latch assembly of claim 16, wherein the first and second linkages each have a peg portion for engaging the linkage notch of the spaced apart leg portions.

18. The latch assembly of claim 13, wherein the first linkage has a post extending away therefrom that is pivotally coupled to a portion of the housing, and the second linkage has a post extending away therefrom that is pivotally coupled to a portion of the cover.

19. A method of increasing latch retraction, comprising the steps of:
disposing a bolt in an interior of a latch housing, the bolt being positionable between an extended position and a retracted position;
coupling a pivotable first linkage to a portion of the housing to engage at least a portion of the bolt, the first linkage having a flared portion defining an undulating peripheral edge;
coupling a rotatable primary cam at least partially adjacent to the first linkage, rotation of the primary cam in a first direction causes it to engage at least a portion of the undulating peripheral edge of the first linkage;
operatively coupling a handle to the primary cam for rotating the primary cam in at least a first direction; and
wherein rotational engagement of the primary cam with the flared portion of the first linkage creates a rotational differentiation between a rate of rotation of the primary cam and a rate of pivoting of the first linkage such that the rate of pivoting of the first linkage is generally greater than a rate of rotation of the primary cam, whereby the increased rate of pivoting of the first linkage translates into an increased linear retraction of the bolt.

20. The method of increasing latch retraction of claim 19, further comprising the step of coupling a pivotable second linkage to a portion of the housing to engage at least a portion of the bolt, the second linkage having a flared portion defining an undulating peripheral edge, wherein rotation of the primary cam in a second direction causes it to engage the flared portion of the second linkage creating a rotational differentiation between a rate of rotation of the primary cam and a rate of pivoting of the second linkage such that the rate of pivoting of the second linkage is generally greater than a rate of rotation of the primary cam, whereby the increased rate of pivoting of the first linkage translates into increased linear retraction of the bolt.

21. The method of increasing latch retraction of claim 20, further comprising the step of positioning the primary cam generally between the first and second linkages.

22. The method of increasing latch retraction of claim 19, further comprising forming a peg on the first linkage that extends into and engages a linkage notch extending into a portion of the bolt.

23. The method of increasing latch retraction of claim 22, wherein the bolt has a body portion and a pair of leg portions with the linkage notch extending into at least a portion of at least one of the leg portions.

24. The method of increasing latch retraction of claim 23, wherein the peg is in continuous engagement with the linkage notch.

25. The method of increasing latch retraction of claim 19, further comprising the step of forming at least one depression in an inner surface of the housing to prevent interferences between the first linkage and the housing.

26. The method of increasing latch retraction of claim 19, further comprising the step of providing at least one stop extending away from the bolt to engage at least a portion of the housing, wherein the stop selectively engages a portion of the housing to limit a maximum extended position of the bolt out of the housing.

27. The method of increasing latch retraction of claim 26, wherein the stop selectively engages a portion of the housing to limit a maximum retracted position of the bolt in the housing.

28. The method of increasing latch retraction of claim 19, further comprising the step of operatively coupling a biasing means to the bolt to move the bolt from the retracted position toward the extended position.
